(19) United States
(12) Patent Application Publication
(10) Pub. No.: US 2013/0068639 A1
(43) Pub. Date: Mar. 21, 2013

(54) Huppy Paint Time Master

(71) Applicant: Gilles Plouffe, Saint-Dominque (CA)

(72) Inventor: Gilles Plouffe, Saint-Dominque (CA)

(21) Appl. No.: 13/701,293

(22) PCT Filed: Jun. 2, 2011
(86) PCT No.: PCT/CA11/00656

§ 371 Date: Nov. 30, 2012

(51) Int. Cl. B44D 3/12

(52) U.S. Cl. CPC B44D 3/12
USPC 206/223

(57) ABSTRACT

All in one integrated paint and tools instant protection container including a composed vertical and horizontal pierced rolling surface for limited roller slip and paint mixing effect. For paintbrush, paint roller and most coatings.

Tools and secondary accessories are orderly supported and at hand always with access to paint. One hand carry all. Open and close at fingertips.

All parts, tools, paint and accessories of the apparatus stay with it at all time in total solidarity implementing a diminished nuisance and augmenting functionality over the traditional array of equipments. No part is to set apart as so to recuperate at no time prior to start or stop or resume.

Fits naturally solid and steady in the staircase conveniently ergonomic.

Hooks solid and steady to the ladder or stepladder with same instant and total functionality while always respecting painter's movements and body space.

Instantly ready with all the tools at hand always and instantly protected in all situations. No cleaning required. Paint and tools stay fresh for a minute or for months. Sponged humidity reserve included.

### PROCESS AND GENERAL KNOW HOW PRIOR TO THE INVENTION

In the application of a coating such as paint, it is common practice to use at the least two paint containers: one is a paint can and goes with the paintbrush while the second container is the tray adapted to a roller. Numerous pieces of equipment are spread over the working area.

For example: paintbrush, roller, roller tray, trolley cart for the roller tray, handle extension, paint can, paint can lid, paint can opener, hammer to close the lid, scraper, sponge, cloth, and many others as well. No one uses all these devices at the same time, however, they all spread scattered over the work area. The user first task is to watch constantly multiple pieces of equipment from dry out just to keep them operational.

Drying tools and containers constantly monitors the user. Also a waste of time every time seeking another tool if not the other container. Sometimes a tool is lost, sometimes stiff whenever if ever found, sometimes solid cured and too late for salvage and has to be discarded. The tedious of protecting equipment against paint drying, often deprives us of a needed break, a call, a meal, a sudden need or an obligation. The painter has to discipline against and in regard of these enumerated and continuous constraints.

No one undertakes a work of painting without planning a sufficient timeframe. We do not open container neither do we fill and dip the tools for simple banter because it is too much work to protect and to wash everything. In some ways this is the material that leads the book, at least the timing and tempo, not the user, otherwise drying takes its toll. A small and short 3 seconds paint touch-up adds up to an easy 10 minutes washing the tools. If working under sunny and windy extreme dry condition as driveway and asphalt coating, tools are difficult to maintain wet. To compensate some users add thinner reducing the quality of the coating.

In addition to this watchdog work, the traditional paintbrush & roller equipment suffers poor design or is prohibitive and even prohibited in various situation such as staircase where frequent travel ups and downs to retender because the paint tray is not sound in the straircase. The ladder is the same and even worst. Using the paint tray in the staircase or in the ladder works at great risk. Even when the roller tray is seated on the floor at best stability, any movement may cause an easy overflow so that the most experienced must be watchful to control.

To counteract the tray problem, pails with rolling surface vertically integrated exist. Behold for to solve a problem, another problem additional is created. The roller slides on the vertical plane rather than rolling. The pail trips forward to fall under pressure to control and stop the slide. One must use both hands and foot to hold the pail from tripping. Thus, this promessfull pail becomes another unnecessary tool container overloading the work area and also increases the work of cleaning and warehousing. Immediately after descending the ladder or staircase, one feels to return to traditional equipment more controllable, more efficient, user-friendly, versatile and despite its many flaws, much more acceptable than such unorganized messy pail which is more of a throw everything anything in.

Washing and protecting paint and accessories is long and tedious. As is also managing the all around discipline and time span sufficient to execute a job from start point to finish line. Again, this is not the user, who leads, but the paint and equipment. As for an overdue touch up we will not to do for we do not want to mess the required equipment and then having to clean for too small a job. So much that one is driven to use only a brush where a roller is needed and preferring making less work and not have a roller and tray to wash. And what about the smart solution to save a wet tool will envelope in a plastic bag for storage in the freezer which is also used for food. Congratulations you did not have to wash the tools. I say paint does not fit with food.

Paintbrush and paint can span with roller and tray is traditionally established. Still the amalgam seriously encroaching some productivity situations and some safety issues. Half of the equipment is poorly designed for the most dangerous places such as staircase, ladder and stepladder. Everything tends to dry while everything shall be easily protected at all time. Often when one wants to stop, it is necessary to continue for the reason to save the tools or save a wash.

Many people would love to paint but cannot support the harsh and time consuming discipline or face the all around responsibility. They hire a painter. This summarizes paintbrush and roller application recurrent difficulties inherent to paint, sealant and other coatings. But not all. As I know of many new tools, equipment and system regularly offered on the market each and all being a solution but always at the price of one added nuisance.

### THE INVENTION HUPPY PAIL

The creative idea of my invention “Huppy Pail” integrates in a single device the paint and equipment listed higher and deploys at any time easy and instantly. The tools are never lost and at hand always. The rolling surface appears as soon the cover deploys with the paint within easy reach. The tools are supported out of the paint. All is instantly protected as soon the cover is closed without any need to wash. Consequently always instantly ready to resume. For a minute or for month paint and tools stay fresh. One hand carries all. Huppy Pail fits naturally in the staircase and hooks to the ladder with full service open or closes at will and fingertips easy.

Climbing back and forth to retemper becomes unnecessary. Performance and safety are at the rendezvous. The work area traditionally crowded all clears out but for one tool Huppy Pail. There is only one single container to manage, to carry and to warehouse. All is user-friendly easier to manage. Besides the elimination of the paint tray for the better, there is also the roller tray trolley also eliminated. Opening takes one second. Closing takes one second. For a break, for several days or for months. Always ready to paint for instant touch-up or for added little bits of spare time that otherwise would be lost forever.

And all this at the price of no additional nuisance. To the contrary and with the benefit of less nuisance. One hand carries all for makes for a safer traveling and working area.

I found that one container of paint properly organised and calculated can advantageously replace the two containers traditionally used without added nuisance.

When you open the lid, my invention deploys a vertical plus horizontal rolling surface Surplus coating is evacuated by holes so roller does not slip so no need to over push on it providing traction. Such arrangement is very stable when pushing on the running rolling surfaces.

In addition, I also found an appropriate way in one single container, to sit brush and roller respectively no nuisance one to the other and isolated properly from the content paint material deeper into the new device all in one container. A major decluttering the work area follows. There is a significant cognitive recovery for better and more efficient work. There is less danger to rear a foot into miscellaneous and damage.

The new arrangement eliminates the need for a roller tray and also for the roller tray trolley cart and still providing equal to superior rolling ability and moving ability. The elimination of the roller tray and its cart disencumbers and makes for a safer working area. Also eliminates overflow when moving the tray. Also eliminates user's back bending right down to the floor. Also eliminates tray liners. This is already a whole lot of money saving and wash saving. Not a single added nuisance with all the advantage.

The tools are never lost. Always the right tool at the right time, that is to say all the time. In addition, dipping and control of the roller becomes easier for it is raised from floor level and nearer the hands and eyes of the user for increased dexterity.

Whether for an extended work or the shortest touch-up, access is instant and immediate. Stop is instant as well. No cleaning is required. Resume at anytime and ready set. No more need more tedious planning preparation of a needed time spans neither spoils clean water or dump into container. Paint skin forming is rarest if non-existent with Huppy Pail. For long period of warehousing over many months, a humid reserve with a sponge is provided. Whenever filled with chlorine it controls odors and bacteria proliferation often coming out of latex.

Huppy new arrangement claims a disencumbered working area for added safety, time recovery from instant ready, cognitive recuperation a compact set up, versatility for it goes in an array of places where no other equipment has ever gone before. It eases on global stress. Less fatigue drives for better work, further and more.

Bonus: no cleaning required saves lots of clean water. It also saves on sink a sewer, curbs and man holes the quick wise guy uses. The one hand carry all illico protects all accessories and coatings to be safely transported to the appropriate place and time promoting a clean and respectful environmental disposal. Or give it to the next user.

A tablet situated inside at the rear in the upper part holds a telescopic handle extension and also serves to deposit the rear roller handle. Underneath the rear or the front support tablet is the humid reserve.

### DRAWINGS AND DESCRIPTION

FIG. 1: Shows the apparatus seen open diagonally from backwards and upwards.

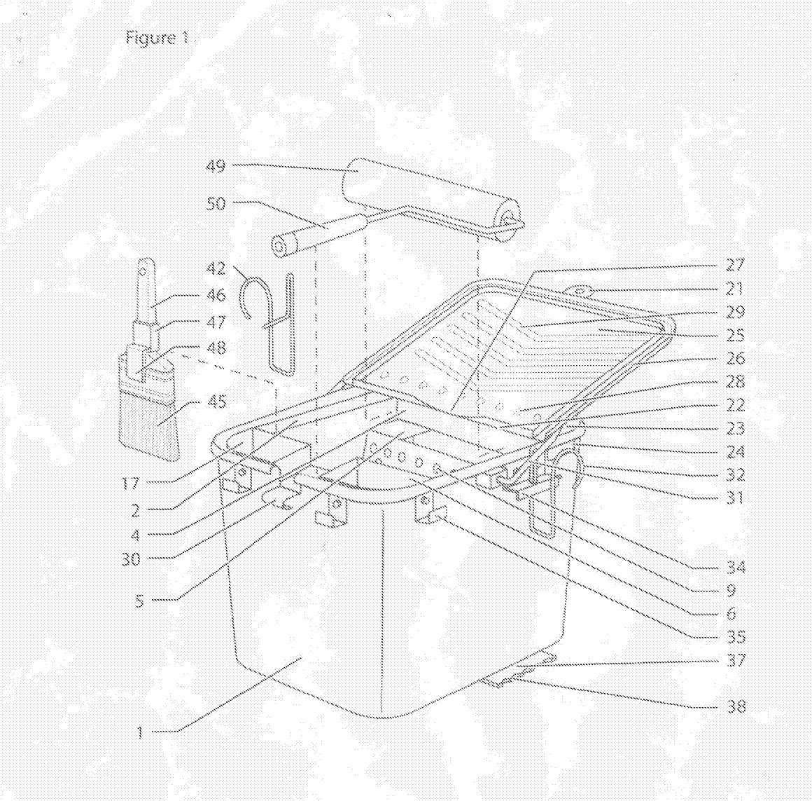

FIG. 2: Shows the apparatus in an exploded view at the same angle as in FIG. 1.

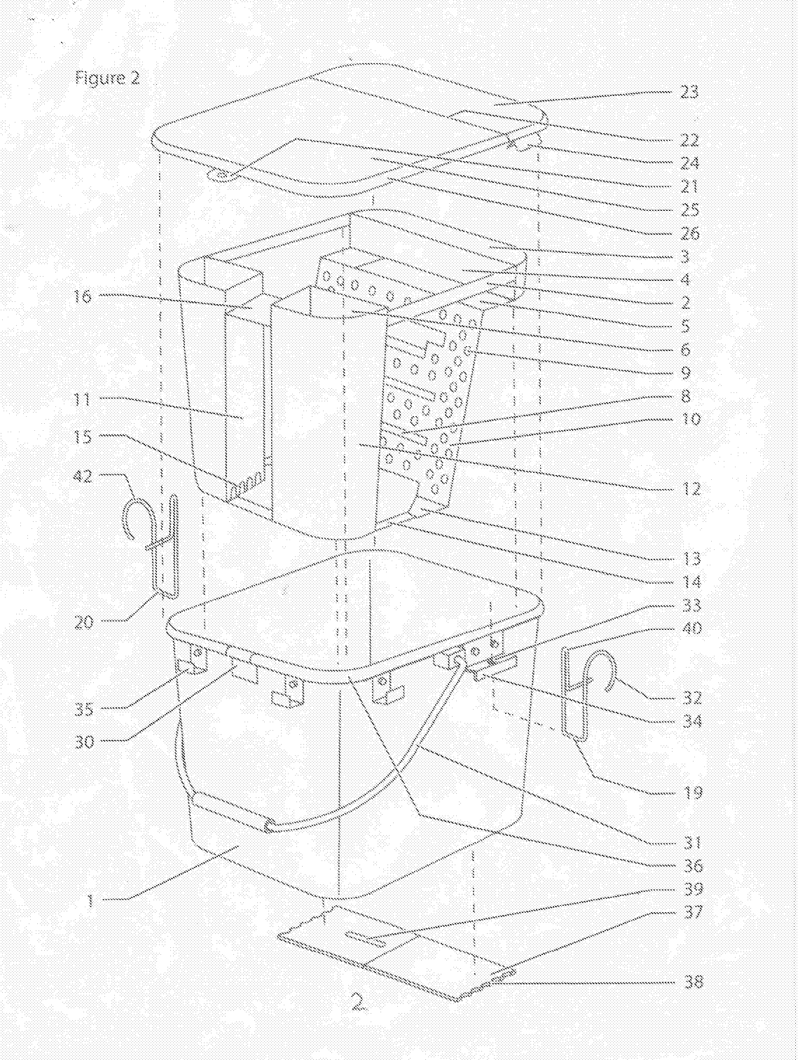

Although the apparatus can be manufactured altogether one piece only, the further description is made in three separated parts for best understanding.

All parts, tools and accessories of the apparatus stay with it at all time in total solidarity implementing a diminished nuisance and augmenting functionality over the traditional array of equipments. No part is to set apart as so to recuperate at no time prior to start or stop or resume. Instantly ready with all the tools at hand always and instantly protected. One hand carry all. Fits naturally solid and steady in the staircase as in the ladder. Again diminishing nuisance and augmenting the all around security and added productivity. The name “Huppy” is on the patent application but it is commercialized under brand name “Paint Time Master”.

### The Container

The illustrated apparatus comprises a container (1) whose lower part contains a coating such as paint. The upper part of the container is an arrangement to support the tools out of the paint while leaving access to it.

Dimensions can be from miniature one quart like up to giant size five gallons and over. One gallon paint capacity is choosen as best ladder size to hook. Still other sizes can fit.

Plastic is chosen for construction of apparatus. Many other materials are also possible such as metal, wood or waxed corrugated paper for an example.

Here the paint is poured into the container. But it might as well be a conventional container such as 3.78 liters can is sitting in the bottom of the container of the device and squinted into the tread of which will be a design similar to the conventional roller tray.

For a better stability the container hooks to a ladder rung, the container is provided with a foot (37) adjustable by slide (39) intended for abuttment on the ladder riser exterior. The foot ends with grip toe (38) to stabilize on the riser.

For holding accessories, the outer periphery of the container is equipped with amenities hooks (35). Hooks may provide interior of container also.

To hook the container to ladder or stepladder, the exterior upper sides of the container are provided with a point or hole (33) for anchoring a hook. solidified by a base (34) and intended to be inserted by a rod (40) which is the container end of the hook. The crochet (32) which is the ladder end of the kook is initiated to the ladder rung. The upper part of the container hangs from the hook while the bottom of the container leans lower on the riser the of ladder. The foot (37) sets the container straight while the grip toe (38) brakes any bottom movement on the riser.

The hooks may be inserted to the container first and then hanged to the ladder. Hooks can be fixed to the container or removable.

As well the hooks may be hanged to the ladder first and then to insert the container.

In the last option, for both sides of the ladder, the hook assembly can be the same fold and manufacture. If so, the hook inserts inverted if right or left. To the right with leg (19) the hook (32) inserts from the rear. To the left with leg (20) the hook (42) inserts from front of the ladder.

A liner (not shown) may be inserted into the container prior to pour the paint and install accessories and tools.

### The Lid (Cover)

A lid composed of a rear part (25) and a front portion (23) and connected together along a hinge line (22), is fitted to the container. The inner periphery of the cover (26) closes on the outer circumference of the container (36) to form a seal.

The rear part lid opens by the finger placed on the crankpin (21) toward the rear still fixed part of the lid and to tilt over it. The rear portion will then be based on the loop (31) positioned on the front of the cover (23) thereof provided with fasteners (24) to secure to the container. The front part which remains attached to the container serves as a support.

Whenever rolling in the lid pushes extra pressure could make the container to trip forward. Not so because the lid hinge(22) provides transfer of gravity counteraction toward center of container.

The lid unfolds as a rolling surface for the roller (49). This surface is provided with embossments (29) and surface peaks (28) to further ensure slip traction.

This inclined rolling surface adds up to the vertical rolling surface (10) and shorter horizontal rolling surface (5) also serving as roller support.

A trench drain (27) redirects the surplus paint back to container.

It is noted that the trench drain could be eliminated and replace by a paint retention capacity configuration similar to the conventional paint tray.

### The Bridge

This part is so named because it supports several elements of the front and the rear of the container and linked or belted together. It rests on the bridge foot (13) in the bottom of the container while pressing the edges all around inside the container.

The bridge consists of various elements (2 to 18) and is inserted into the container. The bridge is here represented as a single piece and is thus retrievable for washing and reuse. The bridge may be one single piece made or many assembled together. It could also be an integral part of the container and apparatus (not shown).

An important portion of the bridge is a rolling surface (10) aligned more or less to the vertical extended with an horizontal plane (5) also serving to support the roller cage (49). Holes (9) and slots (8) are intended for discharge of the excess of paint on the roller and to ensure good traction and easier distribution of the paint on the roller. Vertical plane (4) stops the roller cage frontward travel.

Provision is made for a sponge and wetland reserve (3) shows in the front upper part of container. This provision can also be put in the rear part.

The assembly rests on the bridge foot (13) in the bottom of the container and links to the rear along the container inner contour with a lower belt (14).

An upper belt (2) in the container inner contour is a lateral support and links together the front upper part of the bridge with its rear counter part mainly composed of a wet bin (11) and a dry bin (12) and belt (16) between the bins. As for example: wet bin access (17) for a wet mixing stick and dry bin access (6) for extension handle or dry rag. Communication holes (15).

The configuration and location of these bins could be different as well as their attachment with the bridge and to the inside contour of the container.

In any case the bridge assembly allows free passage to dip into the paint.

The roller handle (50) rests on a platform (16),

A small rear door (30), allows closing the lid of the container without being necessary to remove the long roller handle extension whenever use fixed.

Whenever a long extension roller handle is fixed to the roller, the long section of the extension leans on the rear (16) and out of the container and away from the floor while the roller cage at front of the container is caught sandwich between its support (5) for the bottom and the fixed part lid (23) for its upper part and while abbuttment (4) stops any forward movement of the roll.

The apparatus comprises an attachment to a brush in order to suspend the bristles (45) downwardly, anywhere on the periphery of the container open,

This attachment comprise a collar (47) for the brush handle (46), and at the other end, a hook (48).

It is understrood that the best way to carry paint and tools is to do it with a all in one closed container. The new arrangement of my apparatus has no need to set apart any of its components or tools as it supports and carries them all at all time. All is available at all time with full integrity and access with no added nuisance or set apart pieces. And this is what sets it apart from everything seen before and including the objections brought my examinator under WIPO.

It takes a second to open as it takes a second to close. Nothing to recuperate or to seek around because everything stays together in the container ready to stop or to resume.

1. A container for receiving a coating substance and a roll comprising a handle and a cage, said container comprising:
a container comprising:
a bottom;
a top opening having a first side and a second &de opposite the first side;
first supporting element and a second supporting element positioned respectively adjacent the first side and the second side of the opening, the first supporting element and the second supporting element being shaped to receive the roller handle and the roller cage respectively, the first support element and second support element defining a passage wide enough to avow access of the roller cage to the bottom of the container, and
a removable lid for covering and sealing the container opening, the lid comprising:
a first surface being parallel and covering a first portion of the container opening, and
a second surface covering a second portion of the container opening complementary to the first portion and rotatable relative to the first surface between a first configuration covering the container opening and a second configuration providing access to the roller cage to the bottom of the container.

2. The container of claim 1, further comprising a first vertical abutment, the first abutment being adapted to prevent the roller cage from rolling forwards when positioned on the second supporting element.

3. The container according to claim 1 or 2, further comprising a second vertical abutment, said second abutment being adapted to prevent the handle from moving backwards when positioned on the first supporting element.

4. The container according to any one of claims 1 to 3, further comprising a horizontal abutment parallel to the second supporting member, below the lid, the horizontal abutment being adapted to retain the sleeve against upward movement when the roller handle is equipped with an extension.

5. The container of claim 1, further comprising a recess for receiving the roller cage, maintaining the roller cage at a distance from the coating substance, stopping the forward movement of the roller cage and retaining the roller cage against any lever effect due to an extension added to the handle, to maintain the extension above ground and within arm's reach of a user.

6. The container according to any one of claims 1 to 5, further comprising a reservoir for a liquid for maintaining humid conditions within the container, separate from the coating substance and upon closing of the container for an extended period.

7. The container according to claim 6, further comprising a sponge for stabilizing and containing the liquid for maintaining humid conditions within the container.

8. The container according to any one of claims 1 to 7, further comprising a secondary compartment therein, which is sealed and positioned at the rear of the container, and characterized in that a rim of a top of the chamber is a support element for a back end of the roller handle, the compartment being adapted to contain one element away from the coating substance.

9. The container according to claim 8, characterized in that the secondary compartment includes adjustable dividers for subdividing a space defined by the secondary compartment.

10. The container according to any one of claims 1 to 9, further comprising at least one hook for tools, the hook being capable of retaining a tool on the outside of the container when the lid is closed.

11. The container according to any one of claims 1 to 10, further comprising an anchor for a ladder, the anchor being adapted to suspend the container on either side on the outside of a ladder step.

12. The container of claim 11, further comprising a pair of adjustment feet, resting on an outer side of the ladder step in order to control leveling of the container upon attachment of the container to the ladder and supported in counterweight on the ladder step.

13. The container according to any one of claims 1 to 12, further comprising a transverse handle tiltable between the front and rear of the container.

14. The container according to claim 13, characterized in that the transverse handle, when swung forwards to a fixed part of the lid, abuts on the fixed part of the lid and provides a support for the rear lid when the rear lid is tilted towards the front.
